(19) United States
(12) Patent Application Publication
(10) Pub. No.: US 2022/0316626 A1
(43) Pub. Date: Oct. 6, 2022

(54) Vent Pipe Seal Fitting

(71) Applicant: 2020 Innovations, LLC, Mt. Vernon, IL (US)

(72) Inventor: James Czerwinski, Scheller, IL (US)

(73) Assignee: 2020 Innovations, LLC, Mt. Vernon, IL (US)

(21) Appl. No.: 17/220,044

(22) Filed: Apr. 1, 2021

(51) Int. Cl. F16L 5/06; F16L 5/10; F16L 15/00

(52) U.S. Cl. CPC F16L 5/06; F16L 5/10; F16L 15/003; F16L 15/04

(57) ABSTRACT

A through the hole vent pipe fitting seal includes a generally hollow cylindrical main body having an annular flange extending outwardly thereof perpendicular to the axis of said main body. An annular sealing member is positioned against a lower surface of the annular flange. An annular clamping member is movably attached on the main body to clamp the seal around a hole in a construction material on which the fitting is to be mounted.

### TECHNICAL FIELD

This disclosure relates to plumbing vent stacks that extend through a wall, or above the roof of a building that vents sewer, HVAC, appliance and other gases. In particular, the present disclosure relates to a vent stack fitting that seals the vent stack as it extends through a hole in a roof or wall created for that vent stack.

### BACKGROUND

Sewer and other vent pipes generally extend upward from behind a sewer trap through the roof or a wall of a building to allow the escape of sewer, HVAC, appliance and other gases safely to the outside of such buildings. In the construction of a building, once the foundation and at least some basic side wall structure is begun, a roof to protect the insides of the building is the next thing to be constructed. A sub-roof of metal or plywood is constructed over a roof framework to provide either a flat roof, an angled roof at various angles, such as 30 or 45 degree roof, etc. An underlayment is next applied over the sub-structure. Various flashings are applied to portions of the roof and thereafter finished roofing materials, such as metal structural panels, sheet panels and various types of shingles, provide the outer protective cover for such roofs. Vent stacks for HVAC equipment and appliances may extend horizontally through a building wall. Roof vent examples, being the most complex, will be shown hereafter. The same principles apply to horizontal vent structures extending through walls.

Heretofore known sewer or other vent stacks have extended vertically straight through holes cut through the underlayment and some or all of the outer protective layer of such roofs. Heretofore known such flashings between a roof and a vent pipe extending through a hole in the roof have included a flat plate portion extending around the hole and vent pipe and positioned under the outer protective layer that includes a more vertical generally cylindrical gasket seal positioned substantially through the outer protective roof layer and vertically upward surrounding the vent stack and potentially over the top of the end of the vent stack.

As such, the seal between the vent stack and the roof occurs up above the protective layer with its weakest point being between the sheet portion and the generally cylindrical upper extending portion of the flashing. After a few years of cyclical seasonal weather, this type of prior known flashing may disintegrate or fail at the prior mentioned weak areas. Additionally, the sheet portion of the flashing may not provide a weather tight seal if the roof covering above the sheet portion of the flashing would disintegrate to the extent that water would invade same above the upper boundary of the sheet flashing.

When the flashing at the vent pipe begins to fail, corrective action involving replacement of the outer protective portion of the roof covering and replacement of the original flashing may be a cost prohibitive procedure. As a result, an industry of protective covers has developed that does not correct the original leak but provides covers over at least a part of the original flashing and the vent stack. Problems with such an arrangement arise from the differing diameters of the vent stacks and differing roof orientations necessitating the protective cover assemblies including at least portions thereof of differing diameters to accommodate such different vent stack diameters and orientations.

A need has developed for a fitting that provides an effective seal between a hole in a building wall or roof and a vent pipe extending therethrough in both new construction and repair.

### SUMMARY

This disclosure relates generally to vent stacks. One implementation of the teachings herein is a through the roof or wall hole vent pipe and seal fitting that includes a generally hollow cylindrical main body including upper and lower body portions each including an outer wall having identical diameters sized to matingly engage the inner diameter of standard vent pipes; said upper and lower body portions positioned adjacent opposing ends of said main body in spatial relation to each other; an annular flange axially inwardly adjacent said upper body portion, said annular flange extending radially outwardly from said upper body portion defining a planer lower surface perpendicular to an axis of said main body; and a fastener receiving portion positioned between said annular flange and said lower body portion.

Another implementation of the teachings herein is a combination through the hole vent pipe and seal fitting assembly that includes a generally hollow cylindrical main body including upper and lower spaced apart body portions sized externally to complimentarily receive at least one of vent pipes and connectors therefor; an annular flange positioned on said main body internally adjacent said upper body portion; an annular rubberized seal member positioned on said main body adjacent said annular flange; and a fastener axially movable on said main body providing a clamping action with said annular flange and said seal member.

Yet another implementation of the teachings herein is a combination through the hole vent pipe and seal fitting assembly that includes a generally hollow cylindrical main body including upper and lower spaced apart body portions sized externally to complimentarily receive at least one of vent pipe and connectors therefor; said generally hollow cylindrical main body further includes a threaded portion positioned between said annular flange and said lower body portion, said threaded portion including outer threads thereon; an annular flange positioned on said main body internally adjacent said upper body portion, said annular flange extends radially outwardly of said generally hollow cylindrical main body portion and having an outer diameter sufficient to cover a vent hole; said annular rubberized seal member having an outer diameter one of substantially equal to and greater than an outer diameter of said annular flange; and a fastener axially movable on said main body providing a clamping action with said annular flange and said seal member.

These and other aspects of the present disclosure are disclosed in the following detailed description of the embodiments, the appended claims, and the accompanying figures.

### BRIEF DESCRIPTION OF THE DRAWINGS

The features of the present disclosure which are believed to be novel are set forth with particularity in the appended claims. The disclosure may best be understood from the following detailed description of currently illustrated embodiments thereof taken in conjunction with the accompanying drawings wherein like numerals refer to like parts, and in which:

FIG. 1 is a horizontal detail view of a first embodiment of a seal fitting, positioned on a horizontal roof or with 90 degree rotation, a wall with additional piping connected thereto, in accordance with implementations of this disclosure;

FIG. 2 is a 3/4 bottom perspective of the first embodiment of the seal fitting in accordance with implementations of this disclosure;

FIG. 3 is a side horizontal view of the first embodiment of the seal fitting in accordance with implementations of this disclosure;

FIG. 4 of a top end vertical view of the first embodiment of the seal fitting in accordance with implementations of this disclosure;

FIG. 5 is a bottom 3/4 perspective view of a main body part of the first embodiment of the seal fitting in accordance with implementations of this disclosure;

FIG. 6 is a perspective view of a threaded clamp member of the first embodiment of the seal fitting in accordance with implementations of this disclosure;

FIG. 7 is a horizontal side view of the main body of the first embodiment of the seal fitting in accordance with implementations of this disclosure;

FIG. 8 is a perspective view of an annular rubber sealing member of the first embodiment of the seal fitting in accordance with implementations of this disclosure;

FIG. 9 is a horizontal detail view of a completed seal fitting assembly and additional piping positioned through a 45 degree angled roof in accordance with implementations of this disclosure; and

FIG. 10 is a vertical detail view of a completed seal fitting with additional piping positioned on a 30 degree angled roof in accordance with implementations of this disclosure.

### DETAILED DESCRIPTION

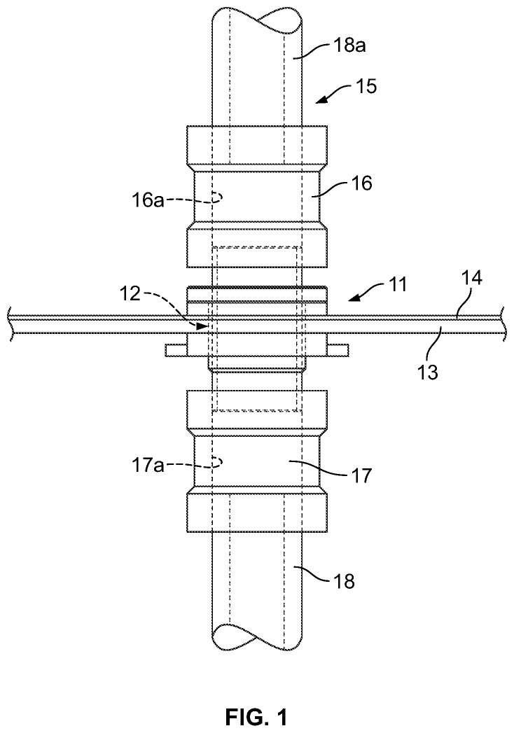

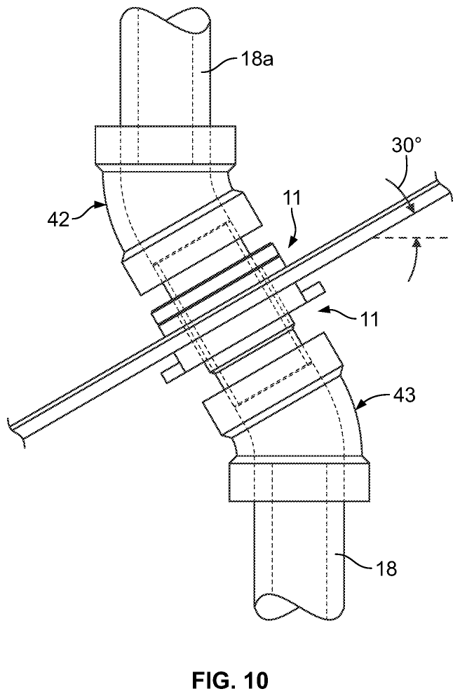

Referring to FIG. 1, a first embodiment of a through the roof or wall seal fitting 11 extends through the hole 12, shown in dotted line in the combination subroof 13 and, in this figure, a metal roof panel or flashing 14. It should be noted that in each of the examples given, FIG. 1, FIG. 9, and FIG. 10, the seal fitting 11 extends perpendicularly through a proper size round hole 12 that extends both through the underlayment 13 and the outer material or flashing 14 to provide for ease of accuracy in mounting the fitting 11 through the hole in the roof or through a wall. The entire stack assembly including the seal fitting and associated piping is identified generally at 15. The vent stack assembly 15 is secured through the round hole 12 in the roof underlayment 13, roofing material or flashing 14, preferably perpendicular to the plane of the roofing or wall material. The stack 15 further includes, in addition to the through the roof or wall seal fitting 11, straight PVC connectors 16 and 17 and continuations of the vent stack including PVC pipe members 18, 18A complete the passage of the vent pipe sealingly through the flat material. The seal fitting 11 may be made of polyvinylchloride (PVC) material, or metal where building codes require same. While the subroof or wall when rotated 90 degrees, 13 in FIG. 1 may be plywood, it could also be of other materials used as subroofs or wall construction materials. Likewise, the metal roof 14 shown in FIG. 1 could also be part of a tar paper subcovering, a metal flashing, sheet roofing materials, shingles, wall insulation, vinyl cladding, or the like. It is an important part of the present disclosure that the through the roof or wall seal fitting is a relatively inexpensive fitting capable of sealing the vent pipe as it passes through a proper sized hole made through the structure.

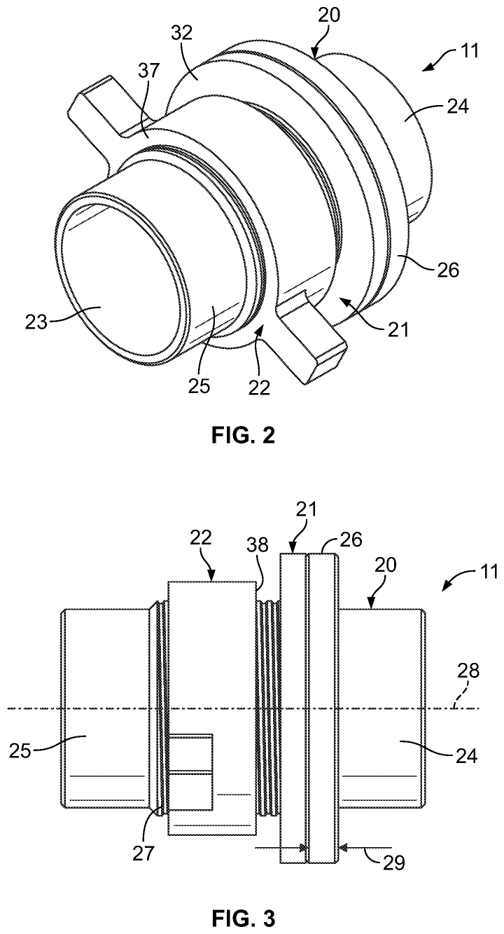

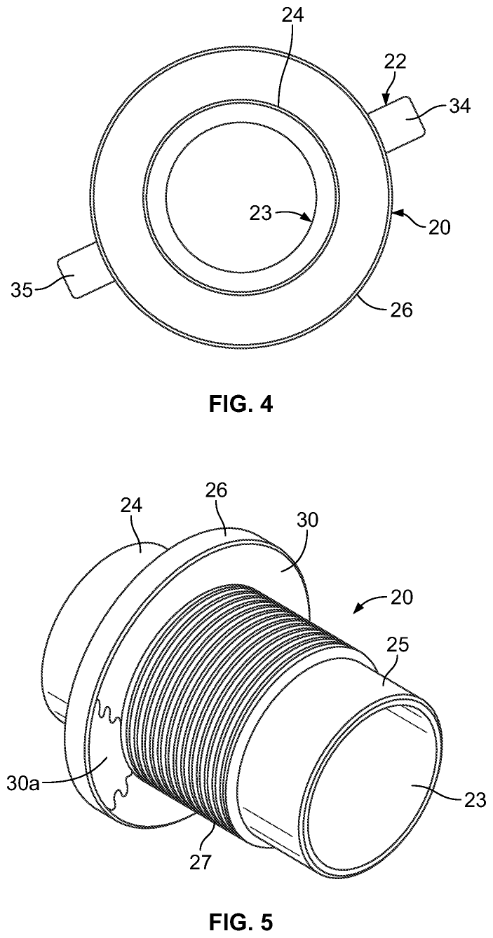

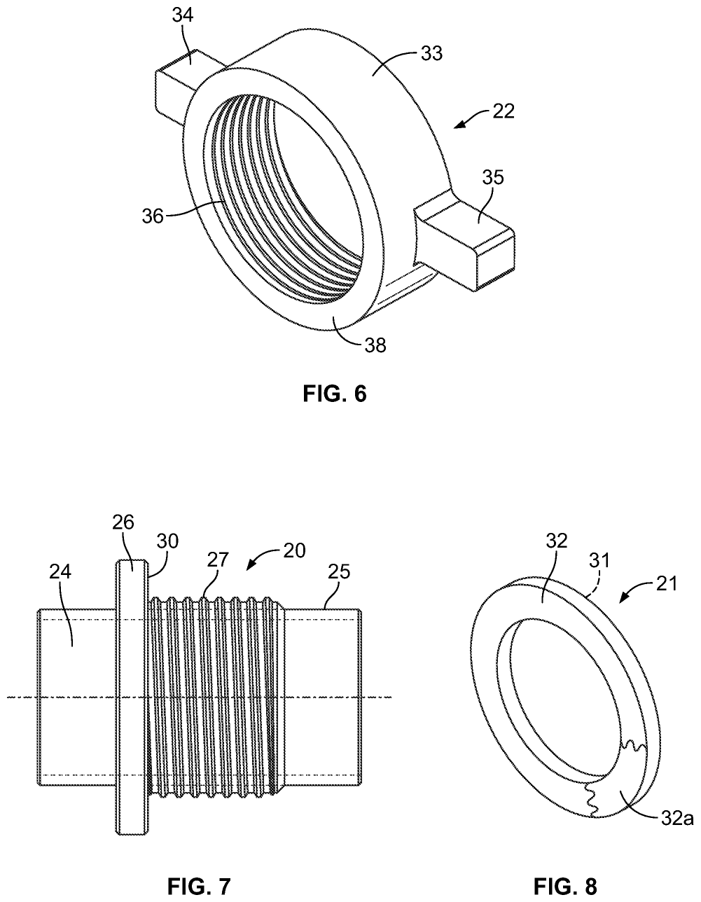

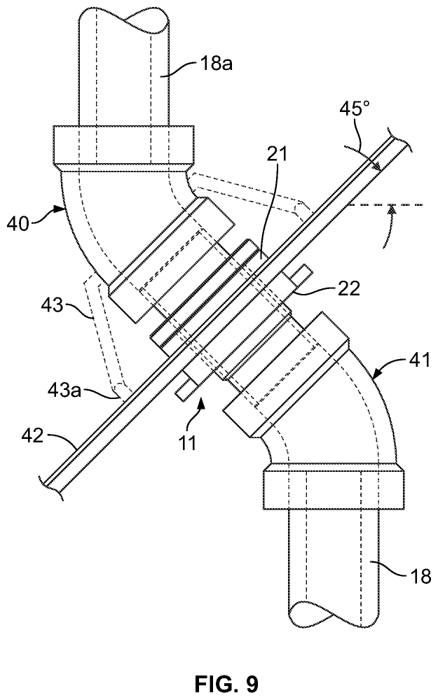

Referring to FIGS. 2-8, the seal fitting assembly 11 comprises a cylindrical main body 20, generally made of PVC or a similar rugged material appropriate for building codes, an annular rubber, or other plastically deformable material, seal 21 retained on the main cylindrical body 20 of the fitting 11, and an annular clamp member or wing nut 22. The annular clamp member or wing nut 22 is preferably threadedly attached to the main cylindrical body 20 of the fitting 11, but can be a push biased annular clamp member to be discussed in more detail below. Thus, it is capable of providing a sealing relationship between the roofing or wall material and a vent stack extending therethrough.

The entire assembly, shown in FIGS. 2 and 3 as assembled together, includes the hollow generally cylindrical main body 20 that is generally a hollow cylindrical structure in one example having an inner diameter sized about 4.00 inches within limits to be complementary to the inner diameter of the tubing of the sewer or HVAC vent stack. The outer diameter of a top portion 24 of the main body 20 and a bottom portion 25 thereof are generally identical and sized at about 4.50 inches to fit the inner diameter of hollow generally cylindrical connectors 16A, 17A shown in FIG. 1. It should be noted that the fitting 11 of the present disclosure can be made in a single size that can matingly engage with reducer connectors (not shown) readily available at hardware stores, or could be made in multiple sizes to complementarily mate with PVC connectors and piping utilized in vent pipes such as nominal 1.5 inch, 2 inch, 3 inch, and 4 inch PVC, metal or other pipes. The main body 20 of the fitting 11 includes inner portions between the top outer diameter 24 and bottom or lower outer diameter 25 including an annular flange 26 about 0.75 inches thick and 7.00 inches in diameter and a fastener receiving or threaded portion 27 about 3.50 inches in length between the annular flange 26 and the lower outer diameter portion 25. In our example, the fitting is about 8.25 inches in length.

Annular flange 26 extends generally radially outwardly of the central cylindrical main body 20 and extends generally perpendicularly to a central axis 28 of the body 20. Annular flange 26 is preferably circular in its outer dimension, and has a thickness 29 that is preferably consistent across the annular flange. In annular flange 26, it is the lower flat annular surface 30, shown most clearly in FIG. 5, which is important because it provides a sturdy mounting for the annular rubberized seal member 21 shown in isolation in FIG. 8. Rubberized sealing member 21 is shaped similarly to annular flange 26 and may have a similar thickness to provide strength and stability along with the annular flange. Washer or seal 21 includes generally flat upper and lower surfaces 31, 32, respectively, sealing the upper surface 31 of seal 21 to the lower surface 30 of annular flange 26 by being generally adhered thereto. When mounted through the hole 12 in a roof, the lower surface 31 and upper surface 32 of annular seal 21 are preferably covered with a silicone or other type sealing material 32A to provide a complete water seal between the rubber seal 21, the annular flange 26, and the top surface of the wall or roof adjacent the hole 12.

In new construction, the round hole 12 is formed through the wall or roof of a size that the washer or seal 21 sufficiently surrounds to form a complete seal. In roof repair, the hole 12 through the roof may be oval in shape. That oval hole may be surrounded with a larger main body fitting, or the hole may be recut to a round shape and a main body fitting with a larger annular flange used with reducing connectors.

Referring to FIGS. 2, 3 and 6, the clamping member or wing nut 22 forms the last member of the through the roof fitting 11. In the illustrated embodiment, wing nut 22 is annular in shape similar to the remaining members of the through the wall or roof fitting 11, and includes a generally cylindrical hollow wall 33 with a wall thickness generally consistent in size. A pair of finger wings 34, 35, which are positioned at 180 degrees opposite each other, extend from the outer surface of wing nut wall 33. On the inside surface of wing nut wall 33 are positioned internal threads 36 that are, in this illustrated embodiment, complementary to the outer threads 27 on the fitting main body 20. The wing nut fingers or extensions 34, 35 are positioned adjacent a lower surface 37 such that the wing nut may be threaded onto the threaded portion 27 of the main body 20 of the fitting 11 with proper spacing for hand tightening. Such action squeezes and seals the roofing material or subroof material to the seal lower surface 32 by threading the wing nut onto those threads 27 until it tightens the roofing material between the wing nut 22 and the seal 21. It should be noted that the internal threads 36 may include deformable plugs or thicker portions of the threads 36 to prevent movement of the wing nut once it has been secured to the bottom of the roofing material to prevent any vibrations from loosening the wing nut when mounted correctly thereon. The clamping member 22 may also be an annular push type fastener that is biased one way to allow the clamp member to mount on a smoother cylindrical portion of the main body to clamp with the annular flange to the wall or roof.

Thus, a complete three member through the wall or roof fitting is shown and described, which is not only simpler than heretofore known vent pipe through the wall or roof mountings or repair flashings, but also provides a superior seal between the area adjacent the hole in the wall or roof and the fitting by being mounted perpendicular 14 to the hole 12, irrespective of the orientation of the roof, wall or other construction material. Since the fitting is a more simplified structure than heretofore known, it can be found in hardware or construction material stores adjacent the plumbing pipe fitting sections of same. FIG. 9 shows an embodiment 11 mounted on a 45 degree angle roof. As with FIG. 1, the wing nut 22 tightly fits the seal member 21 to the roofing material 42 and 43 providing a proper seal therebetween. The only difference is in the 45 degree fittings 40, 41 attached to the top and bottom portions of fitting 11 of the disclosure rather than the straight connectors 16, 17 shown in FIG. 1. As mentioned previously, the fitting 11 of the present disclosure may be made of PVC material or another material meeting building codes. All of these parts other than the fitting 11 of the present disclosure may be inexpensively obtained from hardware or construction material stores in a proper size that provides an overall mounting of the vent stack through the roof or building wall without the necessity of buying a more expensive vent pipe covering having many accessory parts of differing vent pipe sizes that add to the cost of the covering extending over the upper vent pipe and being sealed on the top surface of the roof 42.

Referring to FIG. 10, the embodiment used as a through the roof sealing assembly 11 of the present disclosure is shown being similar to that shown in FIG. 9, however, the sealing assembly 11 in FIG. 10 is mounted on a 30 degree roof with the only difference between that and the sealing assembly 11 shown in FIG. 9 being the use of 30 degree connectors 42 and 43 instead of the 45 degree connectors 40 and 41 shown in FIG. 9. Another advantage of the through the roof sealing assembly 11 of the present disclosure is the mounting of the assembly 11 perpendicularly to the plane of the roof, irrespective of the angle of the roof to the horizontal. This enables the use of a circular hole through the roof, rather than an oval hole that would be required if the vent pipe ran straight vertically through the roof. As such, a more precisely cut hole and more securely obtainable seal between the area adjacent the hole in the roof and the roof sealing member 11 may be obtained than heretofore known through the roof sealing assemblies.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments, it is to be understood that the present disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed:

1. A through the hole vent pipe seal fitting comprising:
a generally hollow cylindrical main body including upper and lower body portions each including an outer wall having identical diameters sized to matingly engage the inner diameter of standard vent pipes;
said upper and lower body portions positioned adjacent opposing ends of said main body in spatial relation to each other;
an annular flange axially inwardly adjacent said upper body portion, said annular flange extending radially outwardly from said upper body portion defining a planer lower surface perpendicular to an axis of said main body; and
a fastener receiving portion positioned between said annular flange and said lower body portion.

2. The through the hole vent pipe seal fitting as defined in claim 1, further comprising:
an annular deformable seal sized and shaped similarly to said radial flange extension from said main body and positioned contiguously against said lower surface of said annular flange.

3. The through the hole vent pipe seal fitting as defined in claim 1, further comprising:
a fastener including an annular body surrounding said main body, said fastener providing a clamping bias between said annular flange and said fastener receiving portion.

4. The through the hole vent pipe seal fitting as defined in claim 1, said fastener receiving portion includes outer threads extending around said main body.

5. The through the hole vent pipe seal fitting as defined in claim 1,
said annular flange has an outer circumference large enough to completely cover a prior existing oval vent hole on an angularly pitched roof.

6. The through the hole vent pipe seal fitting as defined in claim 4, further comprising:
a nut including a central bore therethrough that is internally threaded complementary to said threads of said main body portion.

7. The through the hole pipe seal fitting as defined in claim 6,
said nut is a wing nut including a pair of finger hold detents extending from opposite sides of said nut.

8. A combination through the hole vent pipe seal fitting assembly comprising:
a generally hollow cylindrical main body including upper and lower spaced apart body portions sized externally to complimentarily receive at least one of vent pipes and connectors therefor;
an annular flange positioned on said main body internally adjacent said upper body portion;
an annular rubberized seal member positioned on said main body adjacent said annular flange; and
a fastener axially movable on said main body providing a clamping action with said annular flange and said seal member.

9. The combination through the hole vent pipe seal fitting assembly as defined in claim 8 wherein:
said annular flange extends radially outwardly of said generally hollow cylindrical main body portion and having an outer diameter sufficient to cover a roof vent hole; and
said annular rubberized seal member having an outer diameter one of substantially equal to and greater than an outer diameter of said annular flange.

10. The combination through the hole vent pipe seal fitting assembly as defined in claim 8, said generally hollow cylindrical main body further includes a threaded portion positioned between said annular flange and said lower body portion, said threaded portion including outer threads thereon.

11. The combination through the hole vent pipe seal fitting assembly as defined in claim 10, said fastener comprising:
a threaded nut including internal threads thereon that are complementary to said outer threads on said main body.

12. The combination through the hole vent pipe seal fitting assembly as defined in claim 11, wherein said nut is a wing nut including a pair of opposing finger hold detents extending from opposite sides of said nut.

13. A combination through the hole vent pipe seal fitting assembly comprising:
a generally hollow cylindrical main body including upper and lower spaced apart body portions sized externally to complimentarily receive at least one of vent pipe and connectors therefor;
said generally hollow cylindrical main body further includes a cylindrical fastener receiving portion positioned between said annular flange and said lower body portion;
an annular flange positioned on said main body internally adjacent said upper body portion, said annular flange extends radially outwardly of said generally hollow cylindrical main body portion and having an outer diameter sufficient to cover a roof vent hole;
said annular rubberized seal member having an outer diameter one of substantially equal to and greater than an outer diameter of said annular flange; and
a fastener axially movable on said main body providing a clamping action with said annular flange and said seal member.

14. The combination through the hole vent pipe seal fitting assembly of claim 13, said fastener receiving portion including outer threads thereon.

15. The combination through the hole vent pipe seal fitting assembly of claim 14, said fastener comprising:
a threaded nut including internal threads thereon that are complementary to said outer threads on said main body.

16. The combination through the hole vent pipe seal fitting assembly as defined in claim 15,
said nut is a wing nut including a pair of opposing finger hold detents extending from opposite sides of said nut.
